(19) United States
(12) Patent Application Publication
(10) Pub. No.: US 2025/0094785 A1
(43) Pub. Date: Mar. 20, 2025

(54) WAVEFORM SIGNAL PROCESSING SYSTEM, STRUCTURE EVALUATION SYSTEM, AND WAVEFORM SIGNAL PROCESSING METHOD

(71) Applicant: KABUSHIKI KAISHA TOSHIBA, Tokyo (JP)

(72) Inventors: Takashi USUI, Saitama Saitama (JP); Hiroshi OHNO, Chuo Tokyo (JP)

(73) Assignee: KABUSHIKI KAISHA TOSHIBA, Tokyo (JP)

(21) Appl. No.: 18/761,806

(22) Filed: Jul. 2, 2024

(30) Foreign Application Priority Data
Sep. 19, 2023 (JP) 2023-150687

(51) Int. Cl. G06N 3/0475; G06N 3/08

(52) U.S. Cl. CPC G06N 3/0475; G06N 3/08

(57) ABSTRACT

According to one embodiment, a waveform signal processing system according to an embodiment includes a neural network, a learner, and an extractor. The neural network is configured to generate at least first time-series data on noise and second time-series data on a signal other than noise on the basis of input random noise. The learner is configured to update parameters of the neural network on the basis of a loss function including a main limitation term of which a value becomes lower as synthetic time-series data obtained by adding the first time-series data and the second time-series data generated by the neural network and an observed time-series waveform including noise become more similar to each other. The extractor is configured to extract at least one of the first time-series data and the second time-series data generated by the neural network as a target signal on the basis of the parameters updated by the learner.

### CROSS-REFERENCE TO RELATED APPLICATION

This application is based upon and claims the benefit of priority from Japanese Patent Application No. 2023-150687, filed Sep. 19, 2023, the entire contents of which are incorporated herein by reference.

### FIELD

Embodiments described herein relate generally to a waveform signal processing system, a structure evaluation system, and a waveform signal processing method.

### BACKGROUND

Recently, problems accompanying deterioration of industrial equipment or structures have become apparent. Since a loss is immeasurable when an accident occurs in industrial equipment or a structure, technology for monitoring states of industrial equipment or structures has been developed in the related art. For example, technology of detecting damage in a structure using an acoustic emission (AE) system for detecting elastic waves generated due to occurrence of internal cracks or propagation of internal cracks using a high-sensitivity sensor is known. Acoustic emission is an elastic wave which is generated due to propagation of fatigue cracks of materials. In the AE system, an elastic wave is detected as a voltage signal (an elastic wave) by an AE sensor using a piezoelectric element. Since an elastic wave is detected as a sign of generation of breakage of a material, an occurrence frequency and a signal intensity of the elastic wave are used as indices indicating soundness of the material. Accordingly, technology of detecting a sign of deterioration of a structure using AE systems has been actively studied.

In diagnosis of corrosion of oil tanks, processes of manufacturing industrial equipment, and the like, detection technology based on an AE system has been widely used in Europe and America, and standardization of detection technology based on an AE system has been performed on some targets. As described in Patent Document 1, detection technology based on an AE system is widely used for detection of damage to mechanism components such as gears often used in industrial equipment, and it is known that there are correlations between abnormalities in industrial equipment and AE parameters extracted from signal waveforms of elastic waves. An energy, a root mean square (RMS) value, and a crest value (a crest factor and a value obtained by dividing an absolute value of the amplitude by an RMS value of the amplitude) are known as representative AE parameters.

An elastic wave is generally a weak signal and needs to be detected by enhancing a signal level using a sensor with a high sensitivity and an amplifier with a high degree of amplification. Accordingly, an AE system is vulnerable to noise. In the related art, there is a likelihood that noise will be superimposed to an extent that detection of an elastic wave will be erroneously determined in some environments and it will be difficult to acquire a correct evaluation result. As a representative noise filtering method, a method of improving a signal-to-noise (S/N) ratio by performing filtering of a frequency domain (a low-pass filter or a band-pass filter) is generally used widely. However, it is difficult to achieve this when the frequency domains of noise and an elastic wave overlap. A shape of a signal may be changed by noise filtration. In this case, the evaluation accuracy may decrease. As described above, in the related art, a desired signal may not be acquired in an environment with much noise.

### BRIEF DESCRIPTION OF THE DRAWINGS

FIG. 1 is a diagram illustrating an example of a configuration of a waveform signal processing apparatus according to a first embodiment.

FIG. 2 is a diagram illustrating an example of waveform data of a typical elastic wave.

FIG. 3 is a diagram illustrating processes that are performed by the waveform signal processing apparatus according to the first embodiment.

FIG. 4 is a diagram illustrating a process flow that is performed by the waveform signal processing apparatus according to the first embodiment.

FIG. 5 is a diagram illustrating results of noise reduction based on a technique according to the first embodiment.

FIG. 6 is a diagram illustrating results of noise reduction based on a technique according to the first embodiment.

FIG. 7 is a diagram illustrating waveforms and time-frequency waveforms which are acquired through short-time Fourier transform.

FIG. 8 is a diagram illustrating a relationship between an added noise level and a peak signal-to-noise ratio.

FIG. 9 is a diagram illustrating a relationship between an added noise level and a feature of an elastic wave.

FIG. 10 is a diagram illustrating a relationship between an added noise level and a feature of an elastic wave.

FIG. 11 is a diagram illustrating an example of a configuration of a structure evaluation system according to an embodiment.

FIG. 12 is a diagram illustrating an example of a configuration of a signal processor according to an embodiment.

FIG. 13 is a sequence diagram illustrating a process flow of evaluating a deterioration state in the structure evaluation system according to the embodiment.

### DETAILED DESCRIPTION

The present invention provides a problem to be solved by the present invention is to provide a waveform signal processing system, a structure evaluation system, and a waveform signal processing method that can acquire a desired signal even in an environment with much noise.

According to one embodiment, a waveform signal processing system according to an embodiment includes a neural network, a learner, and an extractor. The neural network is configured to generate at least first time-series data on noise and second time-series data on a signal other than noise on the basis of input random noise. The learner is configured to update parameters of the neural network on the basis of a loss function including a main limitation term of which a value becomes lower as synthetic time-series data obtained by adding the first time-series data and the second time-series data generated by the neural network and an observed time-series waveform including noise become more similar to each other. The extractor is configured to extract at least one of the first time-series data and the second time-series data generated by the neural network as a target signal on the basis of the parameters updated by the learner.

Hereinafter, a waveform signal processing system, a structure evaluation system, and a waveform signal processing method according to an embodiment will be described with reference to the accompanying drawings.

### First Embodiment

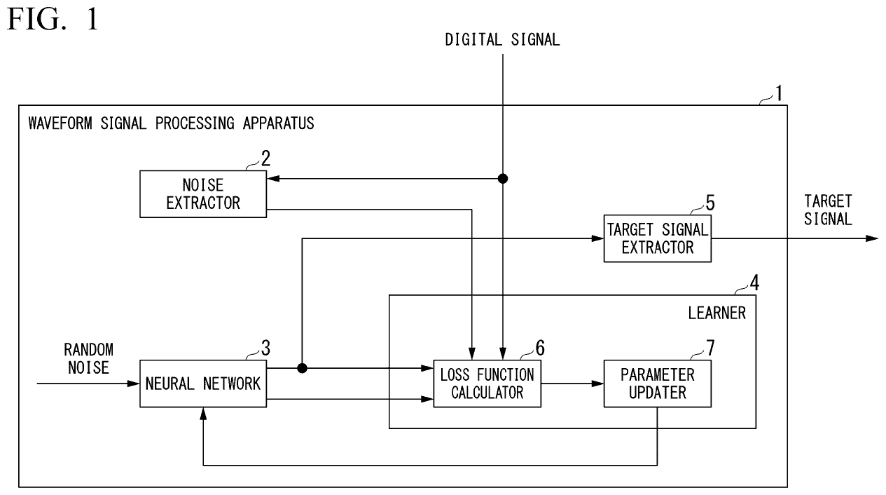

FIG. 1 is a diagram illustrating an example of a configuration of a waveform signal processing apparatus 1 according to a first embodiment. The waveform signal processing apparatus 1 is an apparatus that receives observation data including noise as an input and generates a target signal on the basis of the input observation data. Here, the observation data including noise is, for example, a digital signal that is acquired on the basis of elastic waves detected by one or more sensors installed in industrial equipment, a structure, or the like in which an abnormality is to be detected. The target signal is either an elastic wave or noise. The industrial equipment is, for example, a compressor, a motor, an electric motor, or a pump.

Each sensor detects an elastic wave (an AE wave) that is generated from industrial equipment, a structure, or the like. The sensor converts the detected elastic wave to an electrical signal such as a voltage signal and outputs the electrical signal. For example, a piezoelectric element having sensitivity in a range of 10 kHz to 1 MHz is used as the sensor. The sensor may be of a resonance type having a resonance peak in a frequency range, a wide band type in which resonance is curbed, or the like, and the type of the sensor may be any one thereof. The method with which the sensor detects an elastic wave may be of a voltage output type, a resistance change type, a capacitance type, or the like, and any detection method thereof may be used. An acceleration sensor may be used instead of the sensor. In this case, the acceleration sensor detects an elastic wave generated in industrial equipment, a structure, or the like. Then, the acceleration sensor converts the detected elastic wave to an electrical signal by performing the same processing as the sensor.

For example, an amplifier, an analog filter, and an analog-digital (AD) converter are provided between the waveform signal processing apparatus 1 and the one or more sensors. The amplifier amplifies the electrical signal output from the sensor. The amplifier amplifies the electrical signal, for example, such that it can be processed by the AD converter. The amplifier outputs the amplified electrical signal to the analog filter. The analog filter removes a noise component outside of a predetermined band from the electrical signal. The analog filter is, for example, a band-pass filter (BPF). It is preferable that the band-pass filter used herein employ a filter of which a passband width is sufficiently broad such that a shape of an elastic wave (an AE signal) is not distorted. The electrical signal from which noise has been removed by the analog filter is input to the AD converter. The AD converter quantizes the electrical signal from which noise has been removed and converts the resultant electrical signal to a digital signal. The AD converter outputs the digital signal to the waveform signal processing apparatus 1.

The waveform signal processing apparatus 1 receives the digital signal output from the AD converter as an input. The waveform signal processing apparatus 1 uses a neural network with random noise as input and at least two signals as output and an input digital signal to extract either elastic waves with noise removed from the input digital signal, or noise, as the target signal.

The waveform signal processing apparatus 1 includes a noise extractor 2, a neural network 3, a learner 4, and a target signal extractor 5. The waveform signal processing apparatus 1 is constituted by a processor (a central processing unit (CPU) and a memory. The waveform signal processing apparatus 1 serves as a device including the noise extractor 2, the neural network 3, the learner 4, and the target signal extractor 5 by executing a program.

Some or all of the functional units such as the noise extractor 2, the neural network 3, the learner 4, and the target signal extractor 5 may be realized by hardware such as an application-specific integrated circuit (ASIC), a programmable logic device (PLD), or a field-programmable gate array (FPGA) or may be cooperatively realized by software and hardware. The program may be recorded on a computer-readable recording medium. The computer-readable recording medium is, for example, a non-transitory storage medium such as a portable medium such as a flexible disk, a magneto-optical disc, a read only memory (ROM), or a CD-ROM or a storage device such as a hard disk incorporated into a computer system. The program may be transmitted via an electrical communication line.

Some functions of the noise extractor 2, the neural network 3, the learner 4, and the target signal extractor 5 do not have to be mounted in the waveform signal processing apparatus 1 in advance and may be realized by installing an additional application program in the waveform signal processing apparatus 1.

The noise extractor 2 identifies a noise area in the input digital signal. The noise area is an area in which noise is dominant. A method of identifying a noise area in a digital signal will be described below. A generation timing of an elastic wave is not normally fixed. Accordingly, an elastic wave is stored retroactively by a predetermined pre-trigger number with respect to a timing at which the amplitude of a signal exceeds a predetermined voltage threshold value (arrival time=0). Alternatively, recording of an elastic wave ends at a timing at which the amplitude or an envelope of the elastic wave is considered to be less than a predetermined threshold value or using the elapse of a predetermined number of samples as an ending condition. That is, data in a pre-trigger period immediately before an arrival time is added to data stored as the elastic wave. As a result, an elastic wave is recorded as a series of burst waveforms.

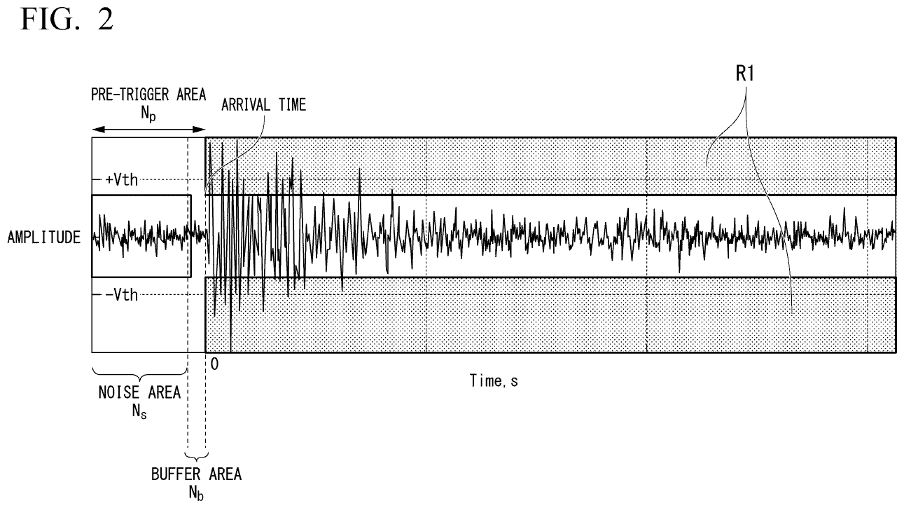

FIG. 2 is a diagram illustrating an example of waveform data of a typical elastic wave. As illustrated in FIG. 2, in the waveform data of an elastic wave, a timing at which the amplitude of a signal exceeds a predetermined voltage threshold value+Vth is an arrival time of an elastic wave, and an area going retroactively by a predetermined pre-trigger number from the arrival time is a pre-trigger area Nₚ. The pre-trigger area Nₚ is an area including data waveforms before the arrival time. In the pre-trigger area Nₚ, the data waveforms immediately before the arrival time may include elastic waves as well as noise and only noise being included becomes more likely going more retroactively from the arrival time. In consideration of this point, the pre-trigger area Nₚ can be partitioned into a noise area Nₛ and a buffer area N_{b} as illustrated in FIG. 2. The noise area Nₛ is an area in which noise is dominant. The buffer area N_{b} is an area in which noise and elastic waves are likely to be mixed. An area R1 in FIG. 2 is an area in which elastic waves are dominant.

The aforementioned measurement method is an example, and another measurement algorithm may be used as long as a signal including an elastic wave and periods before and after the elastic wave is recorded as a hit. That is, when the arrival time is set to 0, an area not including an elastic wave is present in data before the arrival time 0. Strictly, the area is likely to include minute elastic waves even immediately before the amplitude of the signal reaches the threshold value. The area in which minute elastic waves are likely to be included is the buffer area N_{b} illustrated in FIG. 2. By setting data from time 0 to a time point before the buffer area N_{b} as the noise area Nₛ, it is possible to accurately identify the noise area.

In the noise extractor 2, information of a period of the pre-trigger area Nₚ and a period considered to be the buffer area N_{b} is set in advance. The noise extractor 2 generates a mask signal in which the noise area Nₛ is 1 and the other areas are 0 on the basis of the set information of the period of the pre-trigger area Nₚ and the period considered to be the buffer area N_{b} using the input digital signal.

The neural network 3 is a network for generating signals of at least two one-dimensional data arrays using noise as an input. The neural network 3 can be realized, for example, as a combination of a full coupling layer, a transposed convolutional layer in which a resolution is increased by transposing an input, an up-sampling layer, and a convolutional layer, or the like. An activation function can employ a sigmoid function, a ReLU function, a sin function, a tanh function, or the like. As long as input and output conditions are satisfied, the configuration of layers constituting the neural network 3 is not particularly limited. In the following description, it is assumed that the neural network 3 is configured to generate an elastic wave from which noise has been removed (first time-series data) and a noise signal (second time-series data) as signals of two one-dimensional data arrays.

The learner 4 updates parameters (for example, a weight and a bias) of the neural network 3 on the basis of a digital signal input to the waveform signal processing apparatus 1, a mask signal generated by the noise extractor 2, and signals of two one-dimensional data arrays generated by the neural network 3. The learner 4 includes a loss function calculator 6 and a parameter updater 7.

The loss function calculator 6 calculates a loss on the basis of the digital signal input to the waveform signal processing apparatus 1, the mask signal generated by the noise extractor 2, and the signals of two one-dimensional data arrays generated by the neural network 3. The parameter updater 7 updates the parameters of the neural network 3 such that the loss calculated by the loss function calculator 6 approaches 0. The parameter updater 7 updates the parameters, for example, at least 1000 times.

The target signal extractor 5 extracts at least one signal out of the signals of two one-dimensional data arrays generated by the neural network 3 as a target signal. It is assumed that which of a noise-removed elastic wave and a noise signal is set as a target signal by the target signal extractor 5 is set in advance. Accordingly, the target signal extractor 5 extracts the noise-removed elastic wave as a target signal, extracts the noise signal as a target signal, or extracts the noise-removed elastic wave and the noise signal as a target signal according to settings.

### (Description of Processes in Neural Network)

A sequence of generating a target signal that is performed on the basis of the mask signal generated by the noise extractor 2 and the input digital signal by the neural network 3 will be described below. The number of recorded samples of waveforms of one elastic wave is defined as N. It is assumed that observed time-series data y(t) is formed by adding a noise-removed elastic wave x(t) and noise n(t). That is, the time-series data y(t) can be expressed by Expression (1).

$$y ( t ) = x ( t ) + n ( t ) \qquad ( 1 )$$

Signals yᵢ, xᵢ, and nᵢ (where i=0, 1, . . . , N−1) are assumed to be sampled. It is assumed that estimated values \hat{ }xᵢ and \hat{ }nᵢ corresponding to xᵢ and nᵢ are independently generated using the neural network 3. Here, \hat{ } is added to the top of x or n.

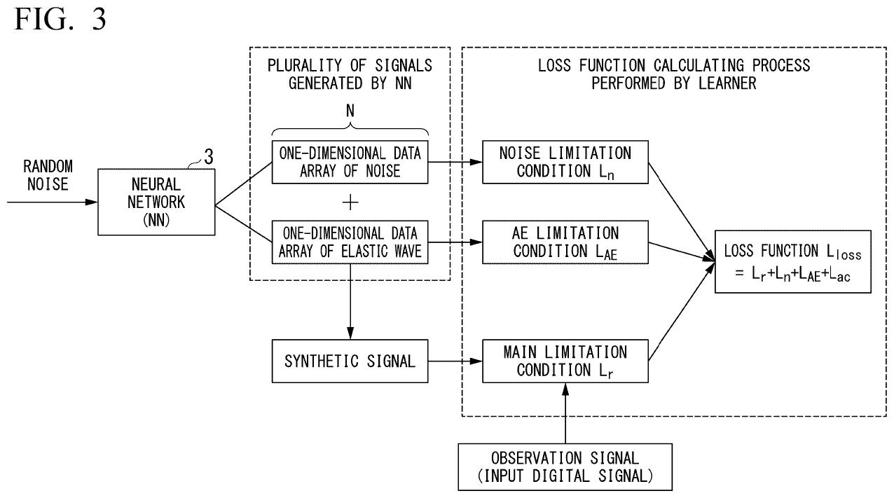

FIG. 3 is a diagram illustrating processes that are performed by the waveform signal processing apparatus 1 according to the first embodiment. As illustrated in FIG. 3, the neural network 3 generates at least two one-dimensional data arrays using noise as an input. Here, two one-dimensional data arrays generated by the neural network 3 are defined to be a one-dimensional data array \hat{ }nᵢ of noise and a one-dimensional data array \hat{ }xᵢ of an elastic wave. Limitation expressed by Expression (2) is provided in the one-dimensional data array \hat{ }nᵢ of noise and the one-dimensional data array \hat{ }xᵢ of an elastic wave. The condition expressed by Expression (2) is defined as a main limitation condition. The one-dimensional data array \hat{ }nᵢ of noise is an example of first time-series data, and the one-dimensional data array \hat{ }xᵢ of an elastic wave is an example of a second time-series data.

$${y}_{i} = {\hat{x}}_{i} + {\hat{n}}_{i} ( i = 0 , 1 … N - 1 ) \qquad ( 2 )$$

When an average value of noise-estimated signals (for example, an input digital signal) in a time window (a head sampling position a and a length w) with an arbitrary length is defined as −n_{a,w} and a variance value thereof is defined as σ_{a,w}², Expression (3) and Expression (4) are established as follows. Here, − is added to the top of n.

$${\overline{n}}_{a , w} = \frac{1}{w} {\sum }_{i = a}^{a + w - 1} {\hat{n}}_{i} \qquad ( 3 )$$

$${σ}_{a , w}^{2} = \frac{1}{w} {\sum }_{i = a}^{a + w - 1} {( {\hat{n}}_{i} - {\overline{n}}_{a , w} )}^{2} \qquad ( 4 )$$

When it is assumed that noise n(t) has weak stationarity and an average and a variance are invariable with a time shift, the average and the variance in the time window with an arbitrary length can be considered to be substantially equal to an average −n_{0,N} and a variance σ_{0,N} in the whole noise. This condition can be expressed by Expression (5), where a stride width by which a time window with an arbitrary width w is shifted is defined as k and the number of steps is defined as i.

$${\sum }_{i = 0}^{I} ( \vert {\overline{n}}_{i * k , w} - {\overline{n}}_{0 , N} \vert + \vert {σ}_{i * k , w} - {σ}_{0 , N} \vert ) = 0 \qquad ( 5 )$$

Here, I=floor ((N−w)/k) is defined. Here, floor is a function of rounding down to the decimal point. As described above, since noise is dominant in the pre-trigger period, the pre-trigger period can be considered to be Expression (6) using a mask signal Mᵢ (where i=0, 1, . . . , N−1) in which the pre-trigger period is 1 and the other area is 0. The mask signal Mᵢ represents an i-th element in the whole mask signal array (a mask signal M).

$$MSE ( {M}_{i} * {y}_{i} , {M}_{i} * {\hat{n}}_{i} ) = 0 \qquad ( 6 )$$

MSE (Mean Square Error) in Expression (6) indicates a mean square error. On the other hand, since an elastic wave is a physical vibration phenomenon, the elastic wave is expected to be nonstationary but to continuously vary in the time axis. This is expressed through limitation as expressed by Expression (7) such that an average of absolute values of second-ordered differential is equal to or less than a reference value δ.

$$\frac{1}{N} {\sum }_{i = 0}^{N - 1} \vert \frac{{d}^{2} {\hat{x}}_{i}}{{dt}^{2}} \vert < δ \qquad ( 7 )$$

In addition, δ is practically defined as sufficiently small, a loss function is defined by Expression (8), and δ may be applied with a priority lower than that of other limitation conditions by appropriately adjusting coefficients at the time of introduction into the loss function which will be described later.

$$‖ \frac{{d}^{2} \hat{x}}{{dt}^{2}} ‖ \qquad ( 8 )$$

By combining these conditions, the loss function Lₗₒₛₛ is defined as expressed by Expression (9). C₁, C₂, and C₃ in Expression (9) are one or more coefficients.

$${ℒ}_{loss} = {ℒ}_{r} + {C}_{1} \cdot {ℒ}_{AE} + {C}_{2} \cdot {ℒ}_{n} + {C}_{3} \cdot {ℒ}_{ac} \\ and , {ℒ}_{r} = ‖ y - ( \hat{x} + \overline{n} ) ‖ \\ {ℒ}_{AR} = ‖ \frac{{d}^{2} \hat{x}}{{dt}^{2}} ‖ \\ {ℒ}_{n} = {\sum }_{i = 0}^{I} ( \vert {\overline{n}}_{i * k , w} - {\overline{n}}_{0 , N} \vert + \vert {σ}_{i * k , w} - {σ}_{0 , N} \vert ) + ‖ M \cdot ( y - \hat{n} ) ‖ \\ {ℒ}_{ac} = \frac{1}{N} {\sum }_{i = 0}^{N - 1} {\hat{x}}_{i} + \frac{1}{N} {\sum }_{i = 0}^{N - 1} {\hat{n}}_{i} \qquad ( 9 )$$

As expressed by Expression (9), the loss function Lₗₒₛₛ is expressed as a combination of a main limitation condition Lᵣ, a noise limitation condition Lₙ, an AE limitation condition L_{AE}, and an alternating current (AC) coupling limitation condition L_{ac}. The main limitation condition Lᵣ is a condition in which a synthetic signal obtained by synthesizing a plurality of signals (the one-dimensional data array \hat{ }nᵢ of noise and the one-dimensional data array \hat{ }xᵢ of an elastic wave) generated by the neural network 3 matches the time-series data y(t) of the digital signal input to the waveform signal processing apparatus 1. The main limitation condition Lᵣ is a term of which a value becomes lower as the synthetic signal becomes more similar to the time-series data y(t) of the digital signal.

The noise limitation condition Lₙ (a noise limitation term) is a limitation condition (stationarity+pre-trigger limitation) representing features of noise. The noise limitation condition Lₙ is a condition including a term of which a value becomes lower as the one-dimensional data array \hat{ }nᵢ of noise becomes more similar to the noise area extracted by the noise extractor 2 and a term of which a value becomes lower as an average or a variance in a first range in the one-dimensional data array \hat{ }nᵢ of noise becomes more similar to an average or a variance in a second range different from the first range. The first range and the second range have a stride width k. The AE limitation condition L_{AE} (a signal limitation term) is a limitation condition (continuity limitation) for expressing features of waveforms of an elastic wave. The AE limitation condition L_{AE} is a term which is expressed to be proportional to the sum of magnitudes of first-order differential or second-order differential of the one-dimensional data array \hat{ }xᵢ of an elastic wave. When the second-order differential is used, a change in slope is more curbed than when the first-order differential is used, and thus it is possible to express a slower signal. In this embodiment, a term expressed to be proportional to the sum of magnitudes of the second-order differential of the one-dimensional data array \hat{ }xᵢ of an elastic wave is used. The AC coupling limitation condition L_{ac} is a condition in which an average value is 0 based on the assumption of AC coupling. L_{ac} may not be included in the loss function Lₗₒₛₛ. Expression (7) may be used as the AE limitation condition L_{AE} in Expression (9).

The loss function calculator 6 calculates a loss on the basis of Expression (9) using the input digital signal, a plurality of signals generated by the neural network 3, and the mask signal M output from the noise extractor 2. The loss function calculator 6 may calculate the noise limitation condition Lₙ by setting at least one of the first range and the second range in the one-dimensional data array \hat{ }nᵢ of noise to the other whenever the parameters are updated. The parameter updater 7 updates the parameters of the neural network 3 to minimize the loss calculated by the loss function calculator 6.

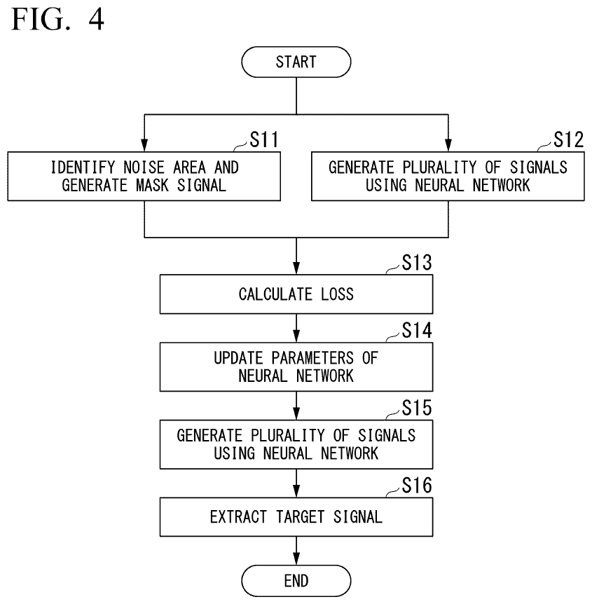

FIG. 4 is a diagram illustrating a process flow that is performed by the waveform signal processing apparatus 1 according to the first embodiment. In the following description, the process flow illustrated in FIG. 4 is described as a target signal extracting process. The process flow illustrated in FIG. 4 is performed when a digital signal is input to the waveform signal processing apparatus 1.

The noise extractor 2 generates a mask signal M using the digital signal input to the waveform signal processing apparatus 1 (Step S11). Specifically, the noise extractor 2 identifies a noise area Nₛ in the digital signal. This means that data corresponding to the noise area Nₛ in the digital signal is identified. The noise extractor 2 generates the mask signal M by setting data corresponding to the identified noise area Nₛ to 1 and setting data of an area other than the noise area Nₛ to 0. The noise extractor 2 outputs the generated mask signal M to the loss function calculator 6.

Random noise is input to the neural network 3. In the neural network 3, initial parameters are set at the time point of starting of the process flow. The neural network 3 generates a plurality of signals on the basis of the initial parameters with the random noise as an input (Step S12). Accordingly, the neural network 3 generates a one-dimensional data array \hat{ }nᵢ of noise and a one-dimensional data array \hat{ }xᵢ of an elastic wave. The neural network 3 outputs the generated one-dimensional data array \hat{ }nᵢ of noise and the generated one-dimensional data array \hat{ }xᵢ of an elastic wave to the loss function calculator 6.

The loss function calculator 6 receives the digital signal, the mask signal M output from the noise extractor 2, and the one-dimensional data array \hat{ }nᵢ of noise and the one-dimensional data array \hat{ }xᵢ of an elastic wave output from the neural network 3 as an input. The loss function calculator 6 calculates a loss on the basis of Expression (9) using the input digital signal, the mask signal M output from the noise extractor 2, and the one-dimensional data array \hat{ }nᵢ of noise and the one-dimensional data array \hat{ }xᵢ of an elastic wave output from the neural network 3 (Step S13). The loss function calculator 6 outputs the calculated loss to the parameter updater 7.

The parameter updater 7 updates the parameters of the neural network 3 on the basis of the loss output from the loss function calculator 6 (Step S14). The method used for the parameter updater 7 to update the parameters is not particularly limited. For example, the parameter updater 7 may update the parameters of the neural network 3 using a gradient method. Thereafter, the parameter updater 7 updates the parameters of the neural network 3 until an update ending condition is satisfied. The update ending condition is a condition for ending update of the parameters of the neural network 3 and may be, for example, a condition in which the update is performed a predetermined number of times (for example, 1000 times) or a condition in which an error is less than a threshold value.

Through the process of updating the parameters of the neural network 3 that is performed by the parameter updater 7, the parameters of the neural network 3 are optimized. The neural network 3 generates a plurality of signals on the basis of the optimized parameters with random noise as an input (Step S15). The target signal extractor 5 extracts one or more signals out of the plurality of signals generated in the process of Step S15 as a target signal (Step S16).

### (Noise Removal Result)

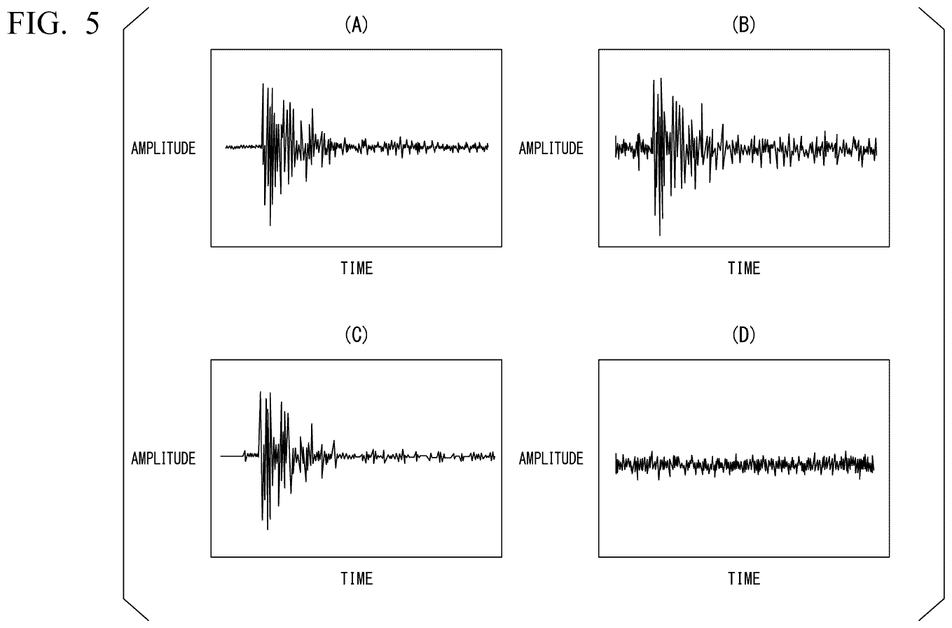

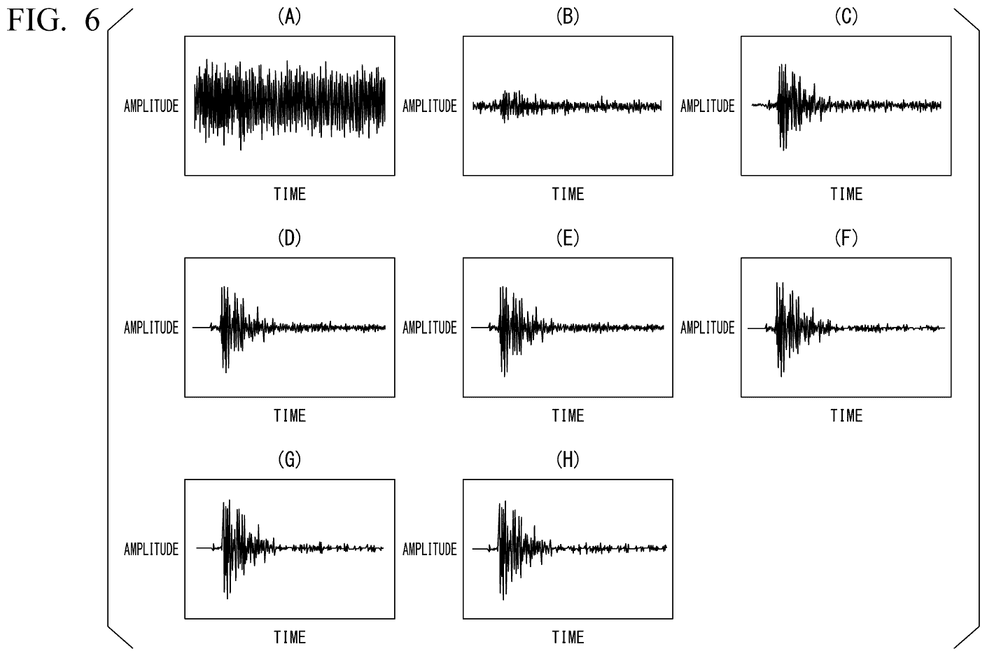

FIGS. 5 and 6 are diagrams illustrating results of noise removal based on the technique according to the first embodiment. (A) of FIG. 5 illustrates a true waveform of an elastic wave (which is originally unknown). (B) of FIG. 5 illustrates an observation waveform acquired by adding white noise to the true waveform of an elastic wave (the waveform illustrated in (A) of FIG. 5). (C) of FIG. 5 illustrates a waveform of an elastic wave generated by the neural network 3 using the technique according to the first embodiment, and (D) of FIG. 5 illustrates a waveform of noise generated by the neural network 3 using the technique according to the first embodiment. Referring to (C) of FIG. 5, it can be seen that a waveform close to the true waveform of an elastic wave is generated using this method.

(A) to (H) of FIG. 6 illustrate waveforms of an elastic wave generated whenever the parameters of the neural network 3 are updated. In the order of (A), (B), (C), (D), (E), (F), (G), and (H) of FIG. 6, the number of times of update of the parameters is set to “0,” “10,” “50,” “100,” “500,” “1000,” “5000,” and “10000.” In (A) of FIG. 6, since the number of times of update of the parameters of the neural network 3 is “0,” a waveform of an elastic wave generated on the basis of the initial parameters by the neural network 3 is illustrated. Referring to (A) to (H) of FIG. 6, it can be seen that noise is removed as the number of times of update of the parameters increases. It can also be seen that a waveform close to (A) of FIG. 5 is acquired when the number of times of update of the parameters is equal to or greater than “1000” as in (F) of FIG. 6. Accordingly, by causing the parameter updater 7 to update the parameters of the neural network 3 1000 times or more, it is possible to accurately acquire the waveform of the elastic wave from which noise has been removed.

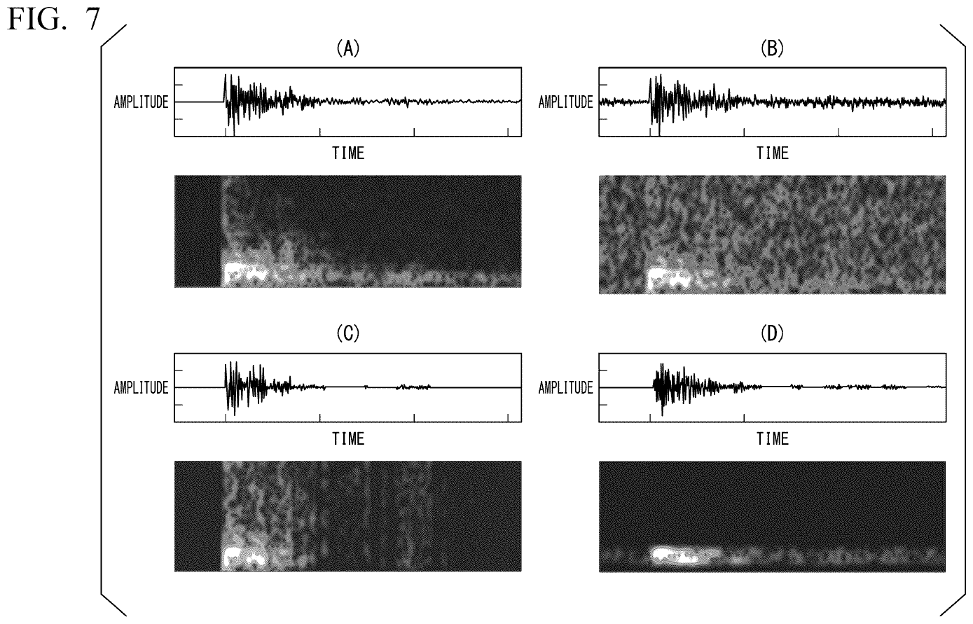

FIG. 7 is a diagram illustrating waveforms and time-frequency waveforms which are acquired through short-time Fourier transform (STFT). (A) of FIG. 7 illustrates a true waveform of an elastic wave, (B) of FIG. 7 illustrates a waveform of an elastic wave with noise added thereto, (C) of FIG. 7 illustrates a waveform of an elastic wave from which noise has been removed using the technique according to the first embodiment, and (D) of FIG. 7 illustrates a waveform of an elastic wave from which noise has been removed using a technique according to the related art (a band-pass filter). As illustrated in (D) of FIG. 7, since filtering of a frequency domain is performed in the related art, it can be seen that a spectrum of a waveform of an elastic wave changes. On the other hand, in the technique according to the first embodiment illustrated in (C) of FIG. 7, it can be seen that noise has been removed while the frequency of the waveform of the elastic wave is maintained.

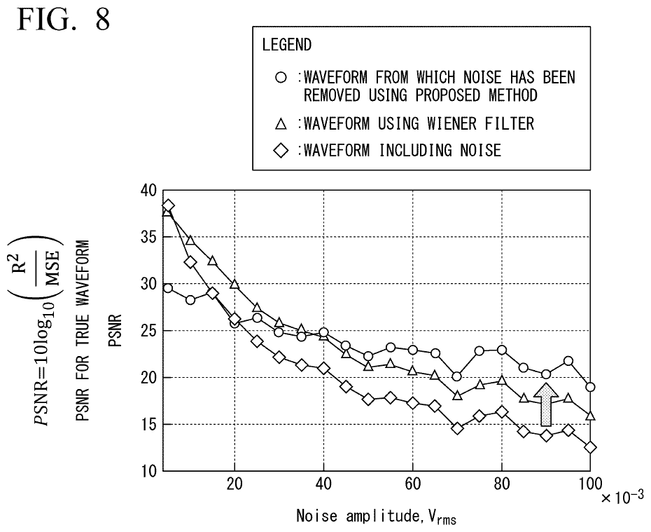

FIG. 8 is a diagram illustrating a relationship between an added noise level and a peak signal-to-noise ratio. The horizontal axis in FIG. 8 represents an added noise level (noise amplitude), and the vertical axis represents a peak signal-to-noise ratio (PSNR) for a true waveform of an elastic wave. The PSNR is a value obtained by multiplying a reciprocal of a mean square error of the true waveform of an elastic wave by a square of the peak amplitude and taking a logarithm of the resultant value and is an evaluation index of signal quality. The PSNR has a larger numerical value as the error becomes less. R used to calculate the PSNR is a coefficient for normalization, and a maximum value of the signal is used. In general, allowable quality is 20 dB or greater.

Here, the PSNR was evaluated using three types of waveforms including a waveform including noise, a waveform from which noise has been removed using the technique according to the first embodiment, and a waveform from which noise has been removed using a Wiener filter for reducing additive noise. As illustrated in FIG. 8, the PSNR of the waveform including noise decreases as the noise level increases. On the other hand, when noise has been removed using the technique according to the first embodiment, it was ascertained that the signal-to-noise ratio (SN) has been improved maximally by 6 dB or more. It can be seen that an effect higher than that using the Wiener filter is achieved in an area with a high noise level.

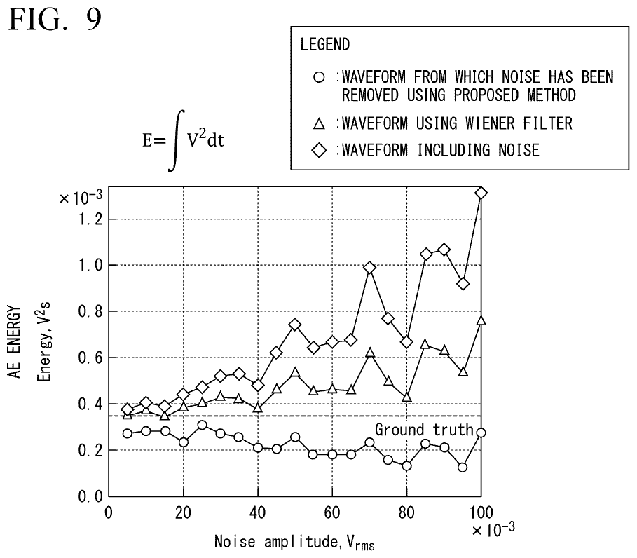

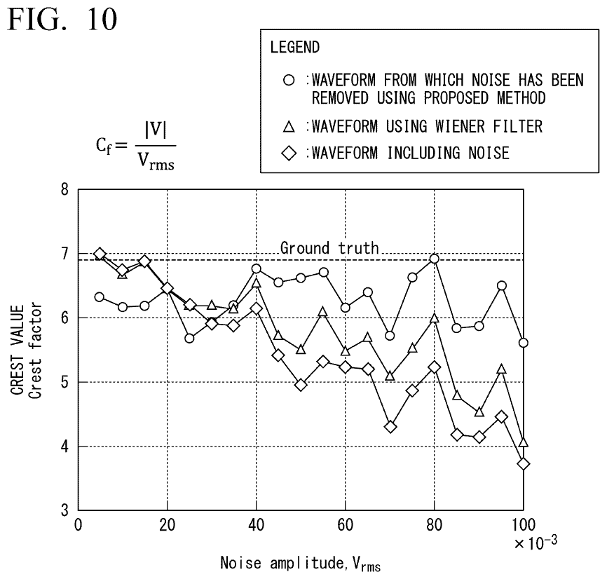

FIGS. 9 and 10 are diagrams illustrating a relationship between an added noise level and a feature of an elastic wave. The horizontal axis of FIG. 9 represents an additive noise level (noise amplitude), and the vertical axis represents AE energy. The horizontal axis of FIG. 10 represents an additive noise level (noise amplitude), and the vertical axis represents a crest value. The AE energy and the crest value are known to have a high correlation with particularly bearing damage and are AE parameters which are often used to detect a bearing abnormality. It can be seen that the value of any AE parameter departs from a true value when the noise level increases. It can be seen that the AE parameter calculated by removing noise using the technique according to the first embodiment presents a value close to a true value even when the noise level increases. In this regard, it is possible to improve an S/N ratio and evaluation accuracy even in an environment with much noise using the technique according to the first embodiment.

The waveform signal processing apparatus 1 having the aforementioned configuration includes the neural network 3 configured to generate at least time-series data on noise and time-series data on a signal other than noise on the basis of input random noise, the noise extractor 2 configured to extract a noise area from an observation time-series waveform (a digital signal) including noise, the learner 4 configured to update parameters of the neural network 3 on the basis of a loss function Lₗₒₛₛ including a main limitation Lᵣ of which a value becomes lower as time-series data of a signal obtained by adding the time-series data of noise and the time-series data of an elastic wave generated by the neural network 3 and the observed time-series waveform become more similar to each other, and the target signal extractor 5 configured to extract at least one of the time-series data of noise and the time-series data of an elastic wave generated by the neural network 3 as a target signal on the basis of the parameters updated by the learner 4. Accordingly, the parameters of the neural network 3 are trained on the basis of the loss function Lₗₒₛₛ including the main limitation condition Lᵣ for making the time-series data of the synthetic signal obtained by adding a plurality of signals generated by the neural network 3 more similar to a digital signal input in real time. The parameters of the neural network 3 are trained on the basis of the loss function Lₗₒₛₛ including a limitation condition representing features of noise and a limitation condition representing features of an elastic wave. Accordingly, the neural network 3 can accurately generate the time-series data of noise and the time-series data of an elastic wave. As a result, it is possible to acquire a desired signal even in an environment with much noise.

The waveform signal processing apparatus 1 does not have to perform learning in advance. Accordingly, it is possible to reduce labor for preparing training data required for learning or time required for learning.

### Second Embodiment

In the first embodiment, the loss function Lₗₒₛₛ is expressed as a combination of the main limitation condition Lᵣ, the noise limitation condition Lₙ, the AE limitation condition L_{AE}, and the AC coupling limitation condition L_{ac}. As described above, the AE limitation condition L_{AE} has lower priority than the other limitation conditions. Therefore, in a second embodiment, a configuration in which a loss function Lₗₒₛₛ is calculated with the AE limitation condition L_{AE} set to “0” to curb a calculational load will be described.

The configuration of the waveform signal processing apparatus 1 according to the second embodiment is the same as in the first embodiment. The waveform signal processing apparatus 1 according to the second embodiment is different from that of the first embodiment in the process performed by the loss function calculator 6. Differences from the first embodiment will be mainly described below.

The loss function calculator 6 calculates a loss on the basis of Expression (9) using an input digital signal, a plurality of signals generated by the neural network 3, and a mask signal M output from the noise extractor 2. At this time, the loss function calculator 6 sets the AE limitation condition L_{AE} in Expression (9) to 0. This substantially means that the loss function Lₗₒₛₛ is expressed as a combination of the main limitation condition Lᵣ, the noise limitation condition Lₙ, the AC coupling limitation condition L_{ac}. Similarly to the first embodiment, the AC coupling limitation condition L_{ac} may not be included in the loss function Lₗₒₛₛ.

In the waveform signal processing apparatus 1 according to the second embodiment having the aforementioned configuration, a loss function with the AE limitation condition L_{AE} set to 0 is used to calculate a loss. Accordingly, it is not necessary to calculate the AE limitation condition L_{AE}. As a result, it is possible to curb a calculational load in comparison with the first embodiment.

### Third Embodiment

In a third embodiment, a configuration in which an AE limitation condition L_{AE} different from that in the first embodiment is used will be described.

The loss function calculator 6 calculates a loss on the basis of Expression (9) using an input digital signal, a plurality of signals generated by the neural network 3, and a mask signal M output from the noise extractor 2. At this time, the loss function calculator 6 sets the AE limitation condition L_{AE} in Expression (9) to a condition represented by Expression (10). Similarly to the first embodiment, the AC coupling limitation condition L_{ac} may not be included in the loss function Lₗₒₛₛ.

$${ℒ}_{AE} = \{ \begin{matrix}‖ ( y - \hat{x} ) ‖ & if y \geq {V}_{th} \\ \hat{x} varies continuously & if y < {V}_{th}\end{matrix} \qquad ( 10 )$$

The AE limitation condition L_{AE} represented by Expression (10) is a condition in which limitation for causing a target signal to conform to an observation signal (an input digital signal) when the amplitude of the signal exceeds a predetermined voltage threshold value is added. As illustrated in FIG. 2, the area in which the amplitude of a signal exceeds the predetermined voltage threshold value (the area R1 in FIG. 2) is an area in which an elastic wave is dominant. Accordingly, it is thought that the likelihood that noise is included in the area in which the amplitude of a signal exceeds the predetermined voltage threshold value is relatively low, and it is thought that the elastic wave varies continuously in an area other than the area R1 after the arrival time in FIG. 2. Therefore, with this idea, the loss function calculator 6 can define a limitation condition more accurately representing features of the elastic wave by using Expression (10) as the AE limitation condition L_{AE}. Expression (7) or Expression (8) can be used as the condition in which an elastic wave varies continuously.

With the waveform signal processing apparatus 1 according to the third embodiment having the aforementioned configuration calculates a loss, the AE limitation condition L_{AE} is expressed in classifications including a case in which the amplitude of a signal exceeds the predetermined voltage threshold value and a case in which the amplitude of a signal does not exceed the predetermined voltage threshold value. Accordingly, it is possible to calculate a loss using a limitation condition more accurately representing features of an elastic wave. As a result, it is possible to more stably generate a target signal.

### Modified Example 1 of Waveform Signal Processing Apparatus 1 According to First to Third Embodiments

The waveform signal processing apparatuses 1 according to the aforementioned embodiments may be configured as a waveform signal processing system using a plurality of information processing devices. In this configuration, some functional units of the waveform signal processing apparatus 1 are mounted in the plurality of information processing devices. For example, the noise extractor 2 may be mounted in a first information processing device and the functional units other than the noise extractor 2 may be mounted in a second information processing device, or the target signal extractor 5 may be mounted in the first information processing device and the functional units other than the target signal extractor 5 may be mounted in the second information processing device.

For example, when the target signal extractor 5 is mounted in the first information processing device, the second information processing device transmits a plurality of signals generated by the neural network 3 of which parameters have been updated to the first information processing device. Out of the plurality of signals transmitted from the second information processing device, the first information processing device extracts a noise-removed elastic wave as a target signal, extracts a noise signal as a target signal, or extracts the noise-removed elastic wave and the noise signal as a target signal according to settings.

### Modified Example 2 of Waveform Signal Processing Apparatus 1 According to First to Third Embodiments

The waveform signal processing apparatuses 1 according to the first to third embodiments may be combined and mounted. Specifically, any configuration according to the first to third embodiments may be used for the loss function calculator 6 to calculate a loss. The first to third embodiments are different from each other in the AE limitation condition L_{AE} used for the loss function calculator 6 to calculate a loss. When the waveform signal processing apparatuses 1 according to the first to third embodiments are combined and mounted in this way, which of the AE limitation conditions L_{AE} in the first to third embodiments is to be used may be selected by a user or may be set in advance.

### (System Employing Waveform Signal Processing Apparatus)

A system to which the waveform signal processing apparatuses 1 described above are applied will be described below. An example of a system to which the waveform signal processing apparatus 1 is applied is a system for evaluating soundness of industrial equipment or a structure. In the following description, a structure evaluation system 100 for evaluating soundness of a structure will be exemplified, but the structure evaluation system 100 can be similarly applied to evaluation of soundness of industrial equipment except that a target is different.

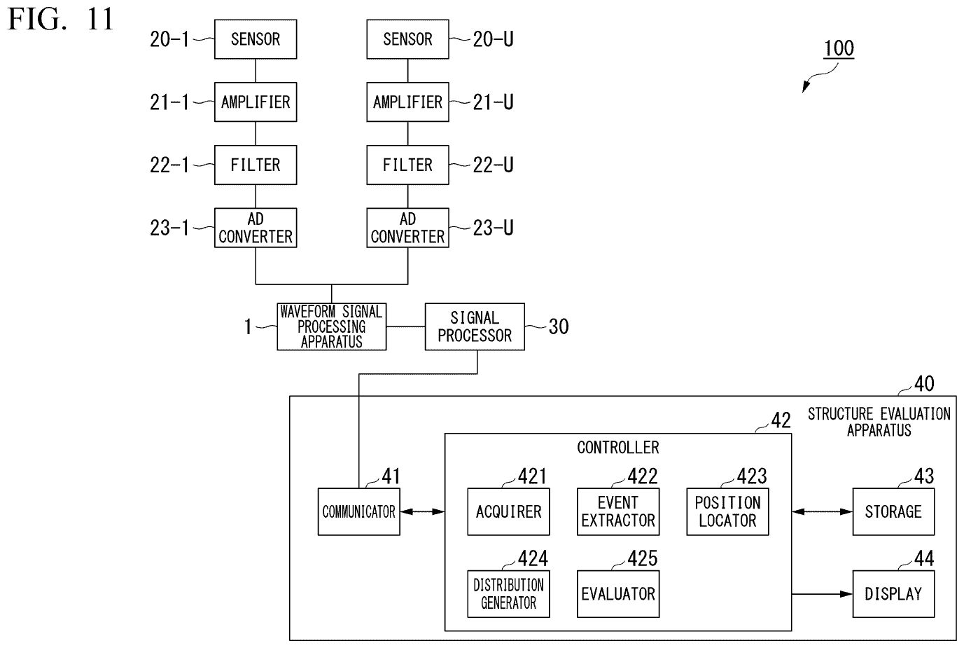

FIG. 11 is a diagram illustrating a configuration of a structure evaluation system 100 according to an embodiment. The structure evaluation system 100 is used to evaluate soundness of a structure. In the following description, evaluation means that a degree of soundness of a structure, that is, a deterioration state of the structure, is determined on the basis of a certain criterion. The deterioration state of a structure may be represented by two levels of soundness and deterioration or may be represented by three or more evaluation levels (for example, soundness “1,” soundness “2,” soundness “3,” . . . in the ascending order of the degree of deterioration) according to a degree of deterioration. When a structure is sound, it means a state in which there is no damage or a state in which damage is generated but quick countermeasures are considered not to be necessary. Deterioration is a state in which damage is generated and quick countermeasures are necessary.

In the following description, it is assumed that the structure is a bridge, but the structure is not limited to a bridge. The structure is not particularly limited as long as it is a structure in which an elastic wave is generated with formation or propagation of cracks or external impacts (for example, rainfall or artificial rainfall). The bridge is not limited to a structure constructed over a river, a valley, or the like and may include various structures (for example, viaducts of an expressway) provided above the ground surface.

An example of damage affecting evaluation of a deterioration state of the structure is internal damage of the structure hindering propagation of an elastic wave such as cracks, voids, and sand granulation. Cracks include cracks in the vertical direction, cracks in the horizontal direction, and cracks in oblique directions. The cracks in the vertical direction are cracks which are generated in a direction perpendicular to a road surface. The cracks in the horizontal direction are cracks which are generated in a direction parallel to the road surface. The cracks in the oblique directions are cracks which are generated in directions other than the directions parallel to and perpendicular to the road surface. The sand granulation is deterioration in which concrete changes into sand granules at a boundary between asphalt and concrete of a concrete floor slab.

The structure evaluation system 100 includes a plurality of sensors 20-1 to 20-U (where U is an integer equal to or greater than 2), a plurality of amplifiers 21-1 to 21-U, a plurality of filters 22-1 to 22-U, a plurality of AD converters 23-1 to 23-U, a waveform signal processing apparatus 1, a signal processor 30, and a structure evaluation apparatus 40. The sensor 20-u (1≤u≤U) and the amplifier 21-u are communicatively connected to each other in a wired manner, the amplifier 21-u and the filter 22-u are communicatively connected to each other in a wired manner, and the filter 22-u and the AD converter 23-u are communicatively connected to each other in a wired manner. The plurality of AD converters 23-1 to 23-U and the waveform signal processing apparatus 1 are communicatively connected to each other in a wired manner, and the waveform signal processing apparatus 1 and the signal processor 30 are communicatively connected to each other in a wired manner. The signal processor 30 and the structure evaluation apparatus 40 are communicatively connected to each other in a wired or wireless manner.

In the following description, the sensors 20-1 to 20-u are referred to as a sensor 20 when they are not distinguished, the amplifiers 21-1 to 21-U are referred to as an amplifier 21 when they are not distinguished, the filters 22-1 to 22-U are referred to as a filter 22 when they are not distinguished, and the AD converters 23-1 to 23-U are referred to as an AD converter 23 when they are not distinguished.

Each sensor 20 includes a piezoelectric element and detects an elastic wave generated from the inside of the structure. The sensors 20 are installed at positions at which an elastic wave can be detected on the surface of the structure. Specifically, the sensors 20 are installed on a surface other than a surface of the structure on which an impact is applied at the same intervals or different intervals in a vehicle traveling axis direction and a vehicle traveling axis crossing direction. The surface other than the surface on which an impact is applied is, for example, one of a road surface, a side surface, and a bottom surface. The vehicle traveling axis direction indicates a direction in which a vehicle travels on the road surface. The vehicle traveling axis crossing direction indicates a direction perpendicular to the vehicle traveling axis direction. Each sensor 20 converts the detected elastic wave to an electrical signal. In the following description, it is assumed that the sensors 20 are installed on the bottom surface of the structure.

The impact applied to the structure may be, for example, a collision of many objects such as rainfalls with the structure or passage of a vehicle 10 over the structure 50. When a vehicle passes over the structure, a load is applied to a road surface due to a contact of a traveling unit of the vehicle with the road surface. A plurality of elastic waves are generated in the structure due to flexure based on the load. The sensors 20 installed on the bottom surface of the structure can detect the elastic waves generated in the structure.

Each sensor 20 employs, for example, a piezoelectric element having sensitivity in a range of 10 kHz to 1 MHz. The sensor 20 may be of a resonance type having a resonance peak in a frequency range, a wide band type in which resonance is curbed, or the like, and the type of the sensor 20 may be any one thereof. The method with which the sensor 20 detects an elastic wave may be of a voltage output type, a resistance change type, a capacitance type, or the like, and any detection method thereof may be used.

An acceleration sensor may be used instead of the sensor 20. In this case, the acceleration sensor detects an elastic wave generated in the structure. Then, the acceleration sensor converts the detected elastic wave to an electrical signal by performing the same processing as in the sensor 20.

Each amplifier 21 amplifies the electrical signal output from the sensor 20. The amplifier 21 amplifies the electrical signal, for example, such that it can be processed by the AD converter 23. The amplifier 21 outputs the amplified electrical signal to the filter 22.

Each filter 22 removes a noise component outside of a predetermined band from the electrical signal. The filter 22 is, for example, a band-pass filter. The electrical signal from which noise has been removed by the filter 22 is input to the AD converter 23.

Each AD converter 23 quantizes the electrical signal from which noise has been removed and converts the resultant electrical signal to a digital signal. The AD converter 23 outputs the digital signal to the waveform signal processing apparatus 1.

The waveform signal processing apparatus 1 receives a digital signal output from each AD converter 23 as an input. The waveform signal processing apparatus 1 generates a target signal on the basis of the input digital signal. The waveform signal processing apparatus 1 outputs the generated target signal to the signal processor 30. As described above, the target signal is at least one of a noise-removed elastic wave and noise. In the following description, it is assumed that the target signal is a noise-removed elastic wave.

The signal processor 30 receives the target signal output from the waveform signal processing apparatus 1 as an input. The signal processor 30 performs signal processing on the input target signal. The signal processing performed by the signal processor 30 includes, for example, noise reduction and extraction of feature values of an elastic wave. The signal processor 30 generates transmission data including the target signal subjected to the signal processing. The signal processor 30 outputs the generated transmission data to the structure evaluation apparatus 40.

The signal processor 30 is configured as a digital circuit. The digital circuit is realized by, for example, a field-programmable gate array (FPGA) or a microcomputer. The digital circuit may be realized by a dedicated large-scale integration circuit (LSI) device. The signal processor 30 may mount a nonvolatile memory such as a flash memory or a removable memory therein.

The structure evaluation apparatus 40 analyzes transmission data collected from the signal processor 30 and estimates a deterioration state and a deterioration position of a structure. Accordingly, it is possible to perform diagnosis of soundness and efficient maintenance of a structure.

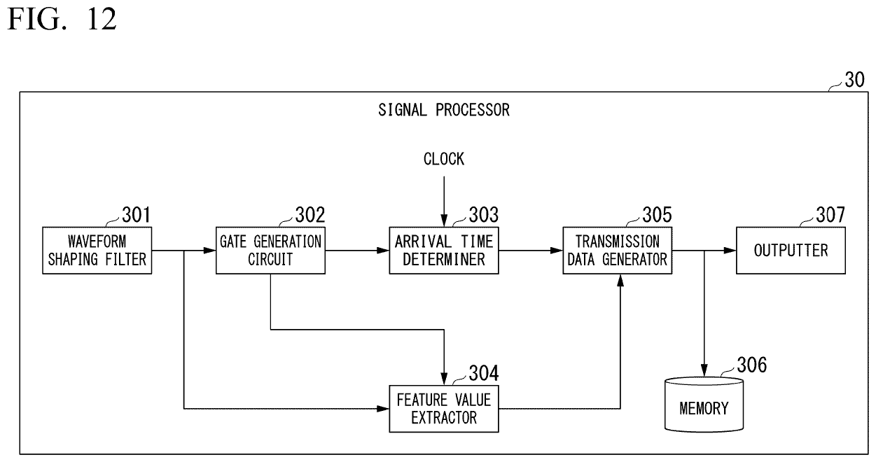

FIG. 12 is a diagram illustrating an example of a configuration of the signal processor 30 according to the embodiment. The signal processor 30 includes a waveform shaping filter 301, a gate generation circuit 302, an arrival time determiner 303, a feature value extractor 304, a transmission data generator 305, a memory 306, and an outputter 307.

The waveform shaping filter 301 removes noise components outside of a predetermined band from the input target signal. The waveform shaping filter 301 is, for example, a digital band-pass filter (BPF). The waveform shaping filter 301 outputs the target signal from which noise components has been removed (hereinafter referred to as a “noise-removed signal”) to the gate generation circuit 302 and the feature value extractor 304.

The gate generation circuit 302 receives the noise-removed signal output from the waveform shaping filter 301 as an input. The gate generation circuit 302 generates a gate signal on the basis of the input noise-removed signal. The gate signal is a signal indicating whether a waveform of the noise-removed signal is sustained.

The gate generation circuit 302 is realized by, for example, an envelope detector and a comparator. The envelope detector detects an envelope of the noise-removed signal. The envelope is extracted, for example, by squaring the noise-removed signal and performing a predetermined process (for example, a process using a low-pass filter or a Hilbert transformation) on the squared output value. The comparator determines whether the envelope of the noise-removed signal is equal to or greater than a predetermined threshold value.

When the envelope of the noise-removed signal is equal to or greater than the predetermined threshold value, the gate generation circuit 302 outputs a first gate signal indicating that the waveform of the noise-removed signal is sustained to the arrival time determiner 303 and the feature value extractor 304. On the other hand, when the envelope of the noise-removed signal is less than the predetermined threshold value, the gate generation circuit 302 outputs a second gate signal indicating that the waveform of the noise-removed signal is not sustained to the arrival time determiner 303 and the feature value extractor 304. A configuration in which the gate generation circuit 302 determines whether the waveform of the noise-removed signal is sustained on the basis of the envelope has been described, but the gate generation circuit 302 may perform a process on the noise-removed signal or a signal employing the absolute value thereof. The threshold value used to generate the gate signal is referred to as a measurement threshold value.

The arrival time determiner 303 receives a clock output from a clock source such as a quartz oscillator which is not illustrated and the gate signal output from the gate generation circuit 302 as inputs. The arrival time determiner 303 determines an elastic wave arrival time using the clock which is input while the first gate signal is being input thereto. The arrival time determiner 303 outputs the determined elastic wave arrival time as time information to the transmission data generator 305. The arrival time determiner 303 does not perform the process while the second gate signal is being input thereto. The arrival time determiner 303 generates cumulative time information after a power-on timing on the basis of the signal from the clock source. Specifically, the arrival time determiner 303 may be a counter for counting edges of a clock, and the value of a register of the counter may be used as time information. The register of the counter is determined to have a predetermined bit length.

The feature value extractor 304 receives the noise-removed signal output from the waveform shaping filter 301 and the gate signal output from the gate generation circuit 302 as inputs. The feature value extractor 304 extracts feature values of the noise-removed signal using the noise-removed signal which is input while the first gate signal is being input thereto. The feature value extractor 304 does not perform the process while the second gate signal is being input thereto. The feature values are information indicating feature values of the noise-removed signal. That is, the feature values of the noise-removed signal are feature values of an elastic wave detected by the sensors 20.

Examples of the feature values include the amplitude [mV] of a waveform, an ascending time [usec] of a waveform, a sustainment time [usec] of a gate signal, a zero-cross count [times], and energy [arb.], a frequency [Hz], and a root mean square (RMS) value of a waveform. The feature value extractor 304 outputs parameters associated with the extracted feature values to the transmission data generator 305. The feature value extractor 304 correlates the parameters associated with the feature values with a sensor ID at the time of outputting the parameters associated with the feature values. The sensor ID indicates identification information for identifying the sensor 20 which is installed in an area in which soundness of the structure is to be evaluated (hereinafter referred to as an “evaluation area”).

The amplitude of a waveform is, for example, a value of the maximum amplitude in the noise-removed signal. The ascending time of a waveform is, for example, a time T1 from an ascending start of the gate signal until the noise-removed signal reaches a maximum value. The sustainment time of the gate signal is a time from an ascending start of the gate signal until the amplitude becomes less than a preset value. The zero-cross count is, for example, the number of times the noise-removed signal crosses a reference line passing through a zero value.

The energy of a waveform is, for example, a value obtained by integrating a square of the amplitude of the noise-removed signal at each time point with respect to the time. Definition of energy is not limited to the aforementioned example, but may be, for example, approximation using an envelope of a waveform. The frequency is a frequency of the noise-removed signal. The RMS value is, for example, a value obtained by squaring the amplitude of the noise-removed signal at each time point and taking a square root thereof.

The transmission data generator 305 receives the sensor ID, the time information, and the parameters associated with the feature values as inputs. The transmission data generator 305 generates transmission data including the input sensor ID, the input time information, and the input parameters associated with the feature values.

The memory 306 stores one or more pieces of transmission data generated by the transmission data generator 305. The memory 306 is, for example, a dual port random access memory (RAM).

The outputter 307 sequentially outputs one or more pieces of transmission data stored in the memory 306 to the structure evaluation apparatus 40. For example, when the signal processor 30 and the structure evaluation apparatus 40 are connected in a wired manner, the outputter 307 outputs one or more pieces of transmission data stored in the memory 306 to the structure evaluation apparatus 40 via a wired cable. When the signal processor 30 and the structure evaluation apparatus 40 are connected in a wireless manner, the outputter 307 outputs one or more pieces of transmission data stored in the memory 306 to the structure evaluation apparatus 40 in a wireless manner.

Description will be continued with reference back to FIG. 11. The structure evaluation apparatus 40 includes a communicator 41, a controller 42, a storage 43, and a display 44. The communicator 41 receives one or more pieces of transmission data output from the signal processor 30.

The controller 42 controls the structure evaluation apparatus 40 as a whole. The controller 42 is constituted by a processor such as a central processing unit (CPU) and a memory. The controller 42 serves as an acquirer 421, an event extractor 422, a position locator 423, a distribution generator 424, and an evaluator 425 by executing a program.

Some or all of the functional units such as the acquirer 421, the event extractor 422, the position locator 423, the distribution generator 424, and the evaluator 425 may be implemented by hardware such as an application-specific integrated circuit (ASIC), a programmable logic device (PLD), or an FPGA or may be cooperatively implemented by software and hardware. The program may be stored in a computer-readable recording medium. The computer-readable recording medium is, for example, a non-transitory storage medium such as a portable medium such as a flexible disk, a magneto-optical disc, a read only memory (ROM), or a CD-ROM or a storage device such as a hard disk incorporated into a computer system. The program may be transmitted via a telecommunication line.

Some of the functional units such as the acquirer 421, the event extractor 422, the position locator 423, the distribution generator 424, and the evaluator 425 do not have to be mounted in the structure evaluation apparatus 40 in advance and may be implemented by installing an additional application program in the structure evaluation apparatus 40.

The acquirer 421 acquires various types of information. For example, the acquirer 421 acquires transmission data received by the communicator 41. The acquirer 421 acquires the transmission data corresponding to an evaluation period. The acquirer 421 stores the acquired transmission data in the storage 43.

The event extractor 422 extracts transmission data in an event out of the transmission data corresponding to the evaluation period stored in the storage 43. The event means an elastic wave generation event having occurred in the structure. The elastic wave generation event in this embodiment is passage of a vehicle over a road surface. The elastic wave generation event is not limited to passage of a vehicle over the road surface and may be application of an impact to the structure. The impact on the structure may be based on a collision of many micro-objects or may be based on artificial actions such as chemical spraying, water spraying, and many strokes using devices or the like. The many micro-objects are objects generated due to meteorological phenomena such as raindrops, hailstones, and snow grains. It is preferable that the impact on the structure be uniformly applied to an evaluation area.

When one event has occurred, an elastic wave is detected substantially at the same time by a plurality of sensors 20. That is, transmission data on the elastic wave detected substantially at the same time is stored in the storage 43. Therefore, the event extractor 422 provides a predetermined time window and extracts all transmission data in which an arrival time is within the width of the time window as transmission data in one event. The event extractor 422 outputs the extracted transmission data in one event to the position locator 423.

The width Tw of the time window may be determined using an elastic wave propagation speed v in the structure to be evaluated and a maximum sensor interval dmax such that Tw≥dmax/v is satisfied. Since Tw is preferably set to be as small as possible in order to avoid erroneous detection, Tw=dmax/v can be substantially set. The elastic wave propagation speed v may be calculated in advance.

The position locator 423 locates positions of elastic wave sources on the basis of sensor position information and sensor IDs and time information included in a plurality of pieces of transmission data extracted by the event extractor 422.

The sensor position information includes information on installation positions of the sensors 20 in correlation with the sensor IDs. The sensor position information includes, for example, information on installation positions of the sensors 20 such as latitude and longitude or distances in the horizontal direction and the vertical direction from a reference position of the structure. The position locator 423 stores the sensor position information in advance. The sensor position information may be stored in the position locator 423 at any timing before position localization of elastic wave sources is performed by the position locator 423.

The sensor position information may be stored in the storage 43. In this case, the position locator 423 acquires the sensor position information from the storage 43 at a timing at which the position localization is performed. A Kalman filter, a least square method, or the like may be used to localize positions of elastic wave sources. The position locator 423 outputs position information of elastic wave sources acquired in the evaluation period to the distribution generator 424.

The distribution generator 424 receives the position information of a plurality of elastic wave sources output from the position locator 423 as an input. The distribution generator 424 generates an elastic wave source distribution using the input position information of the plurality of elastic wave sources. The elastic wave source distribution indicates a distribution in which positions of the elastic wave sources are marked. More specifically, the elastic wave source distribution is a distribution in which points indicating positions of elastic wave sources are marked in virtual data representing the structure to be evaluated with the horizontal axis set to a distance in a passing direction and with the vertical axis set to a distance in the lateral direction.

The distribution generator 424 generates an elastic wave source density distribution using the elastic wave source distribution. The elastic wave source density distribution represents a distribution in which values of densities calculated according to the number of elastic wave sources included in each area are expressed for each predetermined area in the elastic wave source distribution. Specifically, first, the distribution generator 424 divides the elastic wave source distribution into a plurality of areas by partitioning the elastic wave source distribution into predetermined sections. Then, the distribution generator 424 calculates a density of each area by dividing the number of elastic wave sources localized in each area by the area thereof. Then, the distribution generator 424 generates an elastic wave source density for each area by allocating the value of the calculated density for each area to the corresponding area. In this way, the distribution generator 424 generates the elastic wave source density distribution by calculating the densities corresponding to an evaluation area.

The evaluator 425 evaluates a determination state of the structure on the basis of the elastic wave source density distribution generated by the distribution generator 424. For example, the evaluator 425 evaluates an area in which the density of elastic wave sources is equal to or greater than a threshold value in the elastic wave source density distribution to be a sound area and evaluates an area in which the density of elastic wave sources is less than the threshold value to be a damaged area.

The transmission data corresponding to the evaluation period acquired by the acquirer 421 is stored in the storage 43. The storage 43 is constituted by a storage device such as a magnetic hard disk device or a semiconductor storage device.

The display 44 displays an evaluation result under the control of the evaluator 425. For example, as the evaluation result, the display 44 may display the corrected elastic wave source density distribution or may display an area which is considered as a damaged area using a different display mode from that of other areas. The display 44 is an image display device such as a liquid crystal display or an organic electroluminescence (EL) display. The display 44 may be an interface for connecting the image display device to the structure evaluation apparatus 40. In this case, the display 44 generates an image signal for displaying the evaluation result and outputs the image signal to the image display device connected thereto.

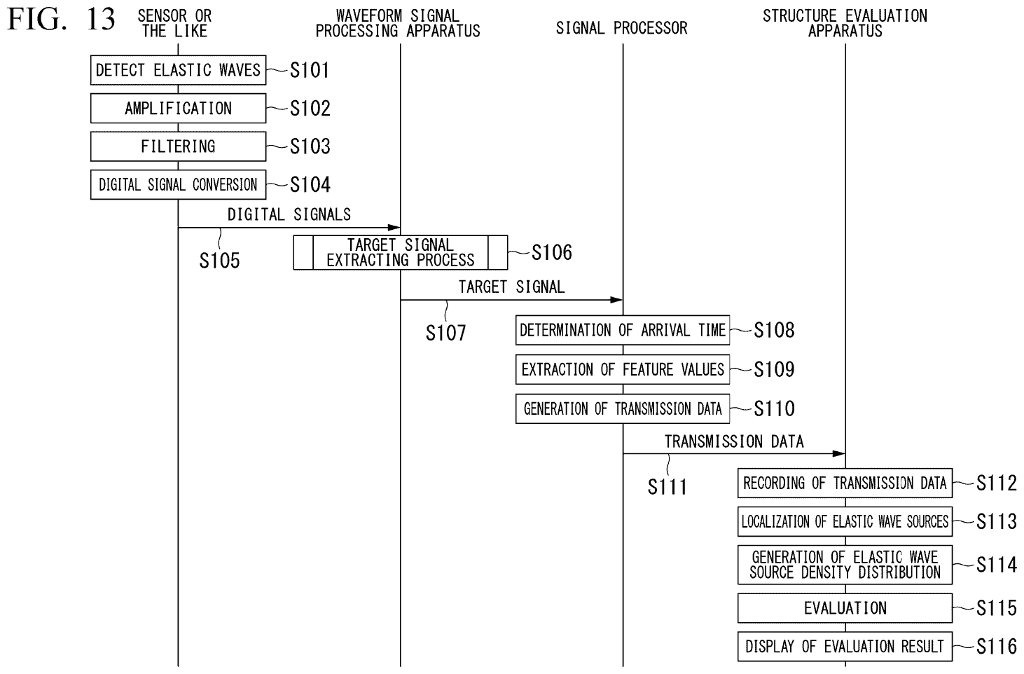

FIG. 13 is a sequence diagram illustrating a flow of a deterioration state evaluating process that is performed by the structure evaluation system 100 according to this embodiment. In FIG. 13, the sensors 20, the amplifiers 21, the filters 22, and the AD converters 23 are described as sensors or the together.

Each of the plurality of sensors 20 detects an elastic wave generated in the structure (Step S101). Each of the plurality of sensors 20 converts the detected elastic wave to an electrical signal and outputs the electrical signal to the corresponding amplifiers 21. Each of the plurality of amplifiers 21 amplifies the electrical signal output from the sensor 20 connected thereto (Step S102). Each of the plurality of amplifiers 21 outputs the amplified electrical signal to the corresponding filter 22.

The amplified electrical signal output from each of the plurality of amplifiers 21 is filtered by the filter 22-u connected to the corresponding amplifier 21-u (Step S103). Accordingly, noise is removed from the amplified electrical signal. The noise-removed electrical signal is input to the corresponding AD converter 23. Each of the plurality of AD converters 23 converts the electrical signal filtered by the filter 22 connected thereto to a digital signal (Step S104). Each of the plurality of AD converters 23 outputs the digital signal to the waveform signal processing apparatus 1 (Step S105).

The waveform signal processing apparatus 1 receives a digital signal output from each AD converter 23 as an input. Since the waveform signal processing apparatus 1 cannot process a plurality of digital signals at the same time, the waveform signal processing apparatus 1 sequentially receives the digital signals output from the AD converters 23 one by one and processes the received digital signal. The waveform signal processing apparatus 1 performs a target signal extracting process on the input digital signal (Step S106). Details of the target signal extracting process are the same as described above with reference to FIG. 4 and thus description thereof will be omitted. As a result, the waveform signal processing apparatus 1 acquires a noise-removed elastic wave as a target signal. The waveform signal processing apparatus 1 outputs the target signal to the signal processor 30 (Step S106).

The signal processor 30 receives the digital signal of an elastic wave which is a target signal output from the waveform signal processing apparatus 1 as an input. For example, the signal processor 30 sequentially receives the noise-removed digital signals output from the waveform signal processing apparatus 1. The arrival time determiner 303 of the signal processor 30 determines an arrival time of each elastic wave (Step S108). Specifically, the arrival time determiner 303 determines an elastic wave arrival time using a clock input while the first gate signal is being input thereto. The arrival time determiner 303 outputs the determined elastic wave arrival time as time information to the transmission data generator 305. The arrival time determiner 303 performs this process on all the input noise-removed digital signals.

The feature value extractor 304 of the signal processor 30 extracts feature values of each noise-removed signal using the noise-removed signals which are digital signals input while the first gate signal is being input thereto (Step S109). The feature value extractor 304 outputs parameters associated with the extracted feature values to the transmission data generator 305. The transmission data generator 305 generates transmission data including the sensor IDs, the time information, and the parameters associated with the feature values (Step S110). The outputter 307 sequentially outputs the transmission data to the structure evaluation apparatus 40 (Step S111).

The communicator 41 of the structure evaluation apparatus 40 receives the transmission data output from the signal processor 30. The acquirer 421 acquires the transmission data received by the communicator 41. The acquirer 421 records the acquired transmission data in the storage 43 (Step S112). The event extractor 422 extracts transmission data in one event out of the transmission data stored in the storage 43. The event extractor 422 outputs the extracted transmission data in one event to the position locator 423.

The position locator 423 locates positions of elastic wave sources on the basis of the sensor IDs and the time information included in the transmission data output from the event extractor 422 and the sensor position information stored therein in advance (Step S113). Specifically, first, the position locator 423 calculates a difference in arrival time of elastic waves between the plurality of sensors 20. Then, the position locator 423 locates the positions of the elastic wave sources using the sensor position information and information of the difference in arrival time.

The position locator 423 performs the process of Step S113 when transmission data in one event is output from the event extractor 422 in the evaluation period. Accordingly, the position locator 423 locates the positions of the plurality of elastic wave sources. The position locator 423 outputs the position information of the plurality of elastic wave sources to the distribution generator 424. The distribution generator 424 generates an elastic wave source distribution using the position information of the plurality of elastic wave sources output from the position locator 423. Specifically, the distribution generator 424 generates the elastic wave source distribution by plotting the positions of the elastic wave sources indicated by the acquired position information of the plurality of elastic wave sources onto virtual data.

The distribution generator 424 generates an elastic wave source density distribution using the generated elastic wave source distribution (Step S114). Specifically, first, the distribution generator 424 divides the elastic wave source distribution into a plurality of areas by partitioning the elastic wave source distribution into predetermined sections. Then, the distribution generator 424 calculates a density of elastic wave sources for each area. Then, the distribution generator 424 generates an elastic wave source density distribution for each area by allocating the density values of elastic wave sources calculated for each area. The distribution generator 424 outputs the generated elastic wave source density distribution to the evaluator 425.

The evaluator 425 evaluates a deterioration state of the structure using the elastic wave source density distribution output from the distribution generator 424 (Step S115). The evaluator 425 outputs an evaluation result to the display 44. The display 44 displays the evaluation result output from the evaluator 425 (Step S116). For example, as the evaluation result, the display 44 may display the elastic wave source density distribution or may display an area which is considered as a damaged area using a different display mode from that of other areas.

In the structure evaluation system 100 having the aforementioned configuration, the waveform signal processing apparatus 1 generates a noise-removed elastic wave as a target signal using a neural network. Accordingly, it is possible to enhance an S/N ratio. As described above, the waveform signal processing apparatus 1 of the structure evaluation system 100 appropriately removes noise while curbing change in shape of a signal waveform as much as possible. The structure evaluation apparatus 40 evaluates damage of a structure using feature values acquired by performing signal processing on the elastic wave from which noise has been removed by the waveform signal processing apparatus 1. Accordingly, it is possible to improve evaluation accuracy of a deterioration state of a structure.

### Modified Example 1 of Structure Evaluation System

In the aforementioned embodiment, a plurality of AD converters 23-1 to 23-U are connected to one waveform signal processing apparatus 1. The structure evaluation system 100 may include U waveform signal processing apparatuses 1, and the AD converters 23-1 to 23-U may be connected to different waveform signal processing apparatuses 1. When U waveform signal processing apparatuses 1 are provided, the structure evaluation system 100 may include U signal processors 30. In this case, the U waveform signal processing apparatuses 1 may be connected to different signal processors 30.

### Modified Example 2 of Structure Evaluation System

Some or all of the functional units of the structure evaluation apparatus 40 may be provided in different devices. For example, the display 44 of the structure evaluation apparatus 40 may be provided in another device. In this configuration, the structure evaluation apparatus 40 transmits an evaluation result to the other device including the display 44. The other device including the display 44 displays the received evaluation result.

### Modified Example 3 of Structure Evaluation System

When the structure evaluation apparatus 40 evaluates a deterioration state of industrial equipment, the structure evaluation system 100 has only to include one or more sensors 20 and the controller 42 of the structure evaluation apparatus 40 has only to include the acquirer 421 and the evaluator 425. When the structure evaluation system 100 includes one sensor 20, one amplifier 21, one filter 22, and one AD converter 23 are provided. One or more sensors 20 are installed in the vicinity of an arc spot of industrial equipment. The one or more sensors 20 detect an elastic wave generated in the industrial equipment and output the detected elastic wave as an electrical signal to the amplifier 21. Thereafter, the processes that are performed by the amplifier 21, the filter 22, the AD converter 23, the waveform signal processing apparatus 1, and the signal processor 30 are the same as in the aforementioned embodiments.

The acquirer 421 acquires transmission data output from the signal processor 30. The evaluator 425 evaluates an abnormality in industrial equipment on the basis of transmission data acquired by the acquirer 421. Specifically, the evaluator 425 evaluates an abnormality in industrial equipment on the basis of a combination of a plurality of feature values acquired from elastic waves. For example, the evaluator 425 evaluates an abnormality in industrial equipment when a ratio at which a correlation between a plurality of feature values of a plurality of elastic waves depart is equal to or greater than a threshold value.

According to at least one embodiment described above, the waveform signal processing system includes the neural network 3 configured to generate at least first time-series data on noise and second time-series data on a signal other than noise on the basis of input random noise, the learner 4 configured to update parameters of the neural network 3 on the basis of a loss function including a main limitation term of which a value becomes lower as synthetic time-series data obtained by adding the first time-series data and the second time-series data generated by the neural network 3 and an observed time-series waveform including noise become more similar to each other, and the target signal extractor 5 configured to extract at least one of the first time-series data and the second time-series data generated by the neural network 3 as a target signal on the basis of the parameters updated by the learner 4. Accordingly, it is possible to acquire a desired signal even in an environment with much noise.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A waveform signal processing system comprising:
a neural network configured to generate at least first time-series data on noise and second time-series data on a signal other than noise on the basis of input random noise;
a learner configured to update parameters of the neural network on the basis of a loss function including a main limitation term of which a value becomes lower as synthetic time-series data obtained by adding the first time-series data and the second time-series data generated by the neural network and an observed time-series waveform including noise become more similar to each other; and
an extractor configured to extract at least one of the first time-series data and the second time-series data generated by the neural network as a target signal on the basis of the parameters updated by the learner.

2. The waveform signal processing system according to claim 1, wherein the learner updates the parameters of the neural network on the basis of the loss function additionally including a noise limitation term which is a limitation condition for expressing features of noise.

3. The waveform signal processing system according to claim 2, further comprising a noise extractor configured to extract a noise area from the observed time-series waveform,
wherein the learner uses a term of which a value becomes lower as the first time-series data becomes more similar to the noise area extracted by the noise extractor as the noise limitation term.

4. The waveform signal processing system according to claim 3, wherein the noise extractor extracts at least a part of time-series data in a pre-trigger period which has been recorded before the amplitude of the observed time-series waveform exceeds a predetermined threshold value as time-series data of the noise area.

5. The waveform signal processing system according to claim 2, wherein the noise limitation term additionally includes a term of which a value becomes lower as an average or a variance in a first range of the first time-series data becomes more similar to an average or a variance in a second range different from the first range.

6. The waveform signal processing system according to claim 5, wherein the learner sets at least one of a first range and a second range to another range whenever the parameters are updated.

7. The waveform signal processing system according to claim 1, wherein the learner updates the parameters of the neural network on the basis of the loss function additionally including a signal limitation term which is a limitation condition for expressing features of a signal other than the noise.

8. The waveform signal processing system according to claim 7, wherein the learner uses a term which is proportional to a sum of magnitudes of a first-order differential or a second-order differential of the second time-series data as the signal limitation term.

9. The waveform signal processing system according to claim 1, wherein the learner performs updating of the parameters at least 1000 times.

10. The waveform signal processing system according to claim 1, wherein the observed time-series waveform is a signal waveform that is obtained as a result of observation of an elastic wave generated due to damage in a structure or industrial equipment using a sensor.

11. A structure evaluation system comprising:
one or more sensors configured to detect an elastic wave generated in a structure or industrial equipment;
the waveform signal processing system according to claim 1 that extracts second time-series data on a signal other than noise as a target signal on the basis of the elastic wave detected by the one or more sensors; and
an evaluator configured to evaluate a deterioration state of the structure or the industrial equipment on the basis of the target signal extracted by the waveform signal processing system.

12. A waveform signal processing method comprising:
generating at least first time-series data on noise and second time-series data on a signal other than noise on the basis of input random noise using a neural network;
updating parameters of the neural network on the basis of a loss function including a main limitation term of which a value becomes lower as synthetic time-series data obtained by adding the first time-series data and the second time-series data generated by the neural network and an observed time-series waveform including noise become more similar to each other; and
extracting at least one of the first time-series data and the second time-series data generated by the neural network as a target signal on the basis of the updated parameters.
